(19) United States
(12) Patent Application Publication
(10) Pub. No.: US 2020/0117501 A1
(43) Pub. Date: Apr. 16, 2020

(54) CUSTOMIZING JVM NATIVE SERVICES

(71) Applicant: CA, Inc., New York, NY (US)

(72) Inventors: Frederic Armand Honore Duminy, St. Charles, IL (US); David Ryan Klopf, Warrenville, IL (US); Gerald Joseph Kauth, Lombard, IL (US); Ronald James Colmone, Arlington Heights, IL (US)

(21) Appl. No.: 16/160,971

(22) Filed: Oct. 15, 2018

(51) Int. Cl. G06F 9/46

(52) U.S. Cl. CPC G06F 9/468

(57) ABSTRACT

Applications can invoke native services provided by an operating system via an interface library of functions. The interface library may provide a more limited set of parameters than the full range of parameters supported by the native services. An application can customize an interface function by requesting that a parameter be added to the parameter list whenever the interface function is called by the application. For example, an application can request that a parameter that is supported by a native service but is not provided by the interface function to the native service be added prior to calling the native service.

### BACKGROUND

The disclosure generally relates to the field of digital processing systems, and more particularly to customizing services provided on digital processing systems.

Modern computer systems can have multiple processors. In some cases, the processors can be of different types. For example, a computer system can have both general purpose processors and specialty processors. Typically, any workload can be executed by the general purpose processors, while there may be restrictions on the types of workloads that can be executed by the specialty processors. If the workloads on a system cannot be executed on the specialty processors, it can result in overloading the general purpose processors and inefficient system performance.

### BRIEF DESCRIPTION OF THE DRAWINGS

Aspects of the disclosure may be better understood by referencing the accompanying drawings.

FIG. 1 is a block diagram illustrating components of a system according to aspects of the disclosure.

FIG. 2 is a flow chart illustrating operations of a method to establish an interface filter to customize native services according to aspects of the disclosure.

FIG. 3 is a flow chart illustrating operations of an intercept filter to customize native services according to aspects of the disclosure.

FIG. 4 depicts an example computer system with an intercept filter.

### DESCRIPTION

The description that follows includes example systems, methods, techniques, and program flows that embody aspects of the disclosure. However, it is understood that this disclosure may be practiced without these specific details. For instance, this disclosure refers to a Java operating system (OS) interface in illustrative examples. Aspects of this disclosure can be also applied to other operating systems. For example, aspects of the disclosure can be applied to a Linux OS interface, or OS interfaces of other programming languages. In other instances, well-known instruction instances, protocols, structures and techniques have not been shown in detail in order not to obfuscate the description.

### Overview

Applications commonly access native services provided by an operating system via interface functions. For example, Java Applications running in a Java Virtual Machine may access a native service of an operating system via an interface function provided in a Java operating system interface library. In some cases, the interface function does not expose the full range of native service parameters to the applications. For example, the Java Virtual Machine may run in an unprivileged state. Thus, the interface function may not expose parameters that may require an elevated privilege level. In some aspects, an application can customize an interface function by requesting that an interface filter be instantiated. The application can provide a directive when instantiating the interface filter. The directive can specify that the interface filter is to add a parameter the parameter list whenever the interface function is called by the application. For example, an application can request that a parameter that is supported by a native service, but is not provided by the interface function to the native service, be added whenever the interface function is called.

The terminology used herein is for the purpose of describing particular aspects and is not intended to be limiting of the disclosure. As used herein, the singular forms “a”, “an” and “the” are intended to include the plural forms as well, unless the context clearly indicates otherwise.

As used herein, a process can be an application process, a service process, a thread, or other unit of executable code that can be scheduled by an operating system for execution on a processor.

The disclosure refers to functions and calling functions. As used herein, a function can be a class method, a subroutine call, a native service call, an interrupt service routine, or other mechanism, that when called, transfers control to the function. The function may or may not return a value to the caller.

Further, as used herein, the term “privilege” refers to a special right or permission granted to perform certain operations, such as to access certain data, execute certain computer code, or execute specific instructions on a processor. For example, a process that has a privilege to access data in a restricted portion of memory is able to read and write data to the restricted portion of memory, whereas a process that does not have that privilege cannot read or write the data in the restricted portion of memory.

### Example Illustrations

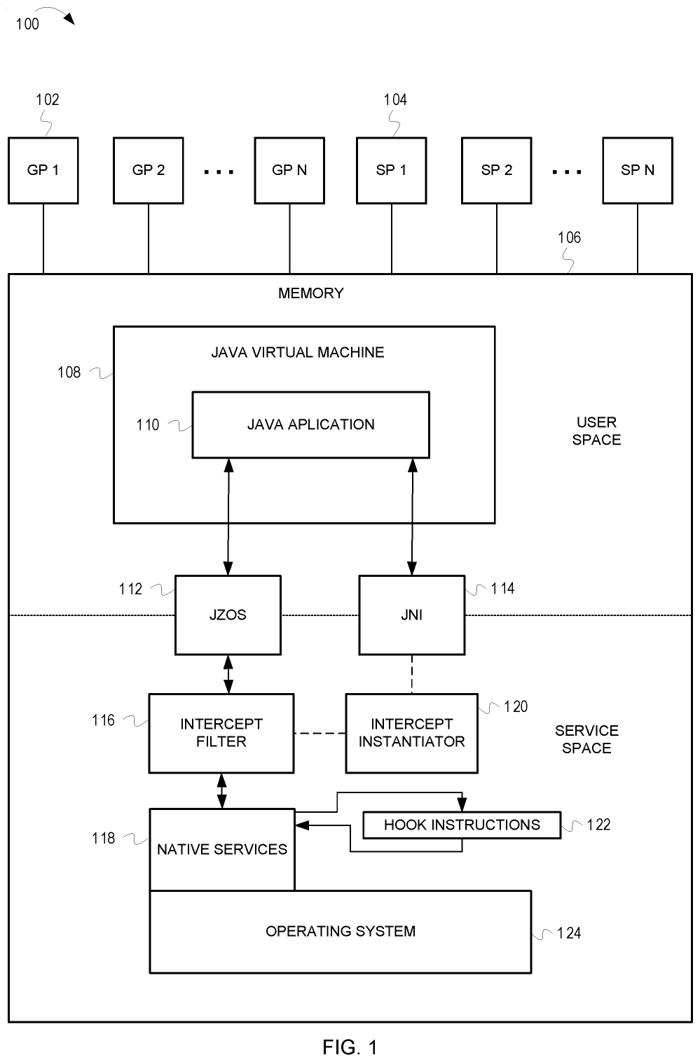

FIG. 1 is a block diagram illustrating components of a system 100 according to aspects of the disclosure. In some aspects, system 100 can include one or more general processors 102, one or more specialty processors 104, and a memory 106 for storing instructions and data for applications and other processes that are executable by a general processor 102 or specialty processor 104.

General processor 102 can be any type of processor that can execute instructions for applications, services, or other processes. In some aspects, general processor 102 is not limited with respect to the types of applications, services or other processes that may run on general processor 102. General processor 102 can be a single core processor or a multi-core processor. Further, general processor 102 or its component cores can be capable of multithreading.

Specialty processor 104 can also be a single core or multi-core processor. Specialty processor 104 may also be capable of multithreading. In some aspects, specialty processor can be limited in one or more ways that general processor 102 is not limited. For example, specialty processor 104 may be have a more limited instruction set, may be restricted from executing certain types of processes or routines and/or dedicated to executing certain types of applications, services, processes or routines.

In some embodiments, system 100 can be a mainframe system. For example, system 100 can be a System z9 or later zSeries system that supports the z/Architecture available from International Business Machines (IBM) Corporation. In such embodiments, specialty processor 104 can be a z Application Assist Processor (zAAP), a z Integrated Information Processor (zIIP) or an Integrated Facility for Linux (IFL) processor. A zAAP is a specialty processor available on some mainframe systems that can be configured to limit execution to Java and XML workloads. Similarly, a zIIP is a specialty processor that can be configured to offload certain types of workloads from general processors. In some aspects, the functionality provided by zAAP processors is integrated with zIIP processors, which is referred to as zAAP on zIIP. In such aspects, the Java or XML workloads can execute on the zIIP processor using zAAP on zIIP.

An operating system 124 can determine which processor will be used to execute a process. For example, an operating system can determine whether a process meets the constraints of a specialty processor 104. If the process does not meet the constraints for the specialty processor 104, the operating system can allocate the process to a general processor 102. Further, a process may initially meet the constraints for running on a specialty processor 104, but later may execute code that does not meet the constraints for running on the specialty processor 104. Thus in some aspects, the operating system 124 can migrate the process from the specialty processor 104 to a general processor 102. If the process later meets the constraints of a specialty processor 104, the operating system 124 can migrate the process back to the specialty processor 104. In some aspects, the operating system 124 can be the z/OS operating system available from IBM Corporation.

The ability of operating system 124 to offload workloads from general processors to specialty processors can increase the efficiency of system 100. The workloads that are offloaded to specialty processors can free general processor resources for allocation to workloads that cannot be executed on the specialty processors.

Further, in some aspects, the use of specialty processors can result in a lower cost to a mainframe user. In some aspects, workloads that are executed on specialty processors may be not be subject to licensing fees associated with running workloads on general processors, or may be subject to a lower license fee when compared to running the workload on the specialty processor.

Memory 106 can be any type of memory that can store data and instructions for execution by the general processors 102 and specialty processors 104 of system 100. In some aspects, memory 106 can be divided into separate spaces, with each space having a different privilege level. In the example illustrated in FIG. 1, memory 106 can be divided into a user space and a service space. Processes executing in the service space typically have a higher privilege level than processes executing in the user space. In alternative aspects, a privilege level can be associated with a process. The privilege level can determine whether or not a process is permitted to access certain data or execute certain routine or instructions. For example, a process executing in user space typically cannot access data that exists in service space.

In some aspects, a Java virtual machine (JVM) 108 can execute from user space in memory 106. The JVM 106 provides an environment for the execution of a Java application 110.

System 100 can include a Java to z/OS interface shown as JZOS 112 in FIG. 1. JZOS 112 provides classes and functions (also referred to as methods) that allow a Java application 110 to make use of native services 116 provided with operating system 124 (e.g., z/OS). In some aspects, JZOS 112 provides a limited subset of the native services 116 provided with operating system 124. Further, the interface functions provided by JZOS 112 may provide a limited subset of the available parameters supported by native service 116. In some aspects, the interface provided by JZOS 112 may not support functions or parameters that would require an elevated privilege level, or require authorization. JZOS is available from IBM Corporation. Those of skill in the art having the benefit of the disclosure will appreciate that other Java-to-OS interfaces can be used and that such interfaces are within the scope of the inventive subject matter.

System 100 can include a Java to native interface shown as JNI 114 in FIG. 1. JNI 114 provides functions that allow Java application 110 to call functions that were written in a different programming language. For example, JNI 114 may provide interfaces to functions written in the C, C++, assembly etc.

The execution characteristics of Java application 110 can affect whether the application is eligible for execution on a general processor 102 or a specialty processor 104. For example, code that executes within the Java application 110 and JVM 108 is typically eligible for execution on a specialty processor 104. Further, code that is executed as a result of a call to a function or method within JZOS 112 is typically eligible for execution on a specialty processor 104. However, code that is executed as a result of a call to a function or method provided by JNI 114 is typically not eligible for execution on a specialty processor 104, and can result in the workload being migrated (at least temporarily) to a general processor 102. This can result in inefficient general processor resource allocation.

As indicated above, the JZOS interface 112 to native services 118 may be limited in that the functions provided by the JZOS interface 112 do not provide the full range of parameters that are supported by their corresponding functions of native services 118. In some aspects, system 100 can include an intercept filter 116 that can be configured to supply parameters that are supported by the functions of native services 118, but not provided by functions of JZOS interface 112. The intercept filter can in effect be inserted between JZOS 112 and native services 118 such that when application 110 makes a function call to a native service via JZOS interface 112, one or more parameters can be added to the call when invoking a native service.

System 100 can include an intercept instantiator 120 that can establish an intercept filter 116. In some aspects, intercept instantiator 120 can be called by Java application 110. In some aspects, intercept instantiator 120 can be included as a process associated with the JNI 114 layer. The process can be configured to switch from a non-authorized state to an authorized state and back. An authorization check can be performed during the initialization of the JVM 108 to determine if the user is authorized to utilize the intercept instantiator. If the user is not authorized, the JVM 108 can terminate. In z/OS implementations, a non-authorized state is referred to as a problem state, and can be determined by a key value of 8-15 and/or problem state attribute set in the program status word (PSW). In such implementations, an authorized state can also be referred to as a supervisor state, and can be determined by a key value of 0-7 and/or problem state attribute not set in the program status word (PSW). If an attempt to access authorized resources is made in a non-authorized state, the operating system and/or the hardware can fail the request. The call to the intercept instantiator 120 by the Java application 110 can specify a function of a native service and a parameter (or parameters) that are to be added in the call to the function when the Java application 110 calls a function in JZOS interface 112.

As an example, the JZOS interface 112, when invoking a system security authorization request, typically does not support a “NOLOG” parameter when calling the native service via the JZOS interface 112. The “NOLOG” parameter allows the native service to be called without logging the call in system logs. It may be desirable for a Java application 110 to be able to call the native service without the call being logged. In such cases, a Java application 110 can call intercept instantiator 120 with a directive specifying the desired native service and that the “NOLOG” parameter is to be added to calls to the native service. Subsequent calls to the native service by Java application 110 via JZOS interface 112 will have the “NOLOG” parameter added prior to invocation of the native service. Those of skill in the art having the benefit of the disclosure will appreciate that there are many parameters in addition to the “NOLOG” parameter that are not supported by the JZOS interface 112, and that adding such parameters via an interface filter 116 as described herein are within the scope of the inventive subject matter.

In some aspects, the interface filter 116 can comprise hook instructions 122. A hook is a set of instructions that can be configured to execute when a function or method is called. For example, the set of instructions in a hook can be configured to execute before or after the main code of the native service executes. The intercept instantiator 120 can configure a hook to execute prior to the native service that is being intercepted. The hook can determine the parameter or parameters to be added before invoking the intercepted native service.

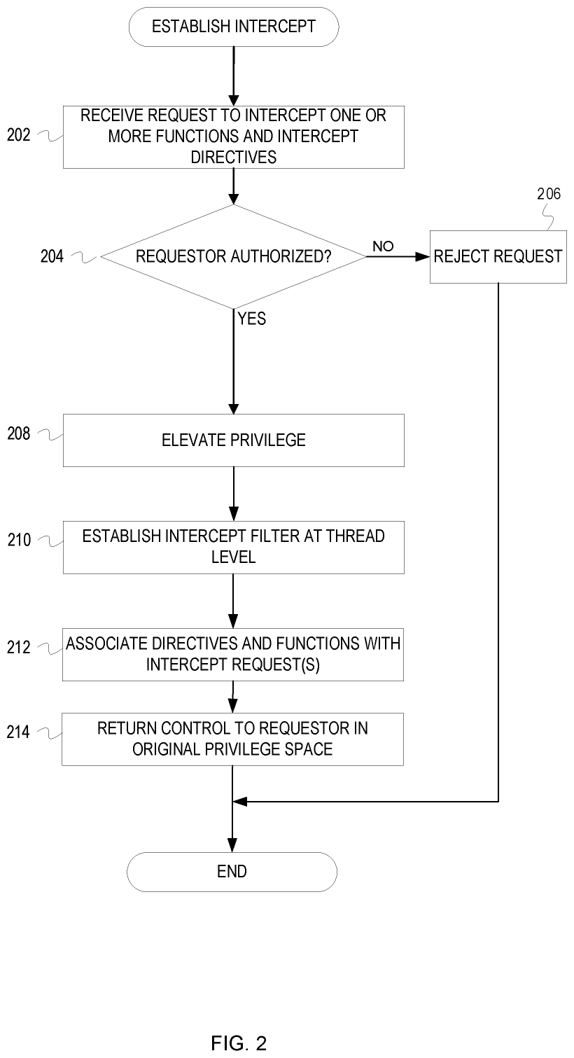

FIG. 2 is a flow chart illustrating operations of a method to establish an interface filter to customize native services according to aspects of the disclosure. The description of FIG. 2 refers to an intercept instantiator performing the operations. The intercept instantiator can be program code installed on a system by the system manufacturer or by a third party independent of the system manufacturer.

At block 202 an intercept instantiator receives a request to intercept one or more functions. For example, the intercept instantiator can receive a request to intercept a function of a native service. The request can include one or more directives associated with the function. For example, the directive in the request can specify one or more parameters (and associated parameter values, if any) that are to be provided to the function when called. In some aspects, a parameter can be added to a parameter list. For example, as indicated above, a “NOLOG” parameter can be added to an existing parameter list to indicate that the system call is not to be logged. In alternative aspects, the parameter list can be modified to remove a parameter. For example, assume that the JZOS interface added a “REQUIRE_LOG” parameter to a system call. A directive can specify that the “REQUIRE_LOG” parameter be removed. In further alternative aspects, a parameter value can be modified. For example, assume that the JZOS interface includes a “LOG=YES” parameter and parameter value to a system call. A directive can specify that the “YES” parameter value be modified to a “NO” value.” The inventive subject matter is not limited to the examples illustrated above. Those of skill in the art having the benefit of the disclosure will appreciate that many other parameters and parameter values could be the subject of a directive.

At block 204, a check is made to determine if the requestor is authorized to make requests to intercept native services. In some aspects, an authorization can be performed at startup as describe above. That is, a determination can be made if authorization exists to start the intercept instantiator. In alternative aspects, authorization can be performed at the JNI layer or by the intercept instantiator. In implementations in the z/OS environment, authorization can be performed by invoking a RACROUTE AUTH call, the z/OS service for security authorization checking. The response will indicate whether access to the resource supplied on the RACROUTE AUTH call for the given user is allowed or denied. In the case of the JNI 114, a deny response code can be passed back to the Java class which will indicate that access by this user has been denied to the resource.

If the requestor is not authorized, the method proceeds to block 206, where the request is rejected. The method then ends.

If the requestor is authorized to make requests to intercept native services, the method proceeds to block 208. At block 208, the intercept instantiator optionally elevates its privilege if necessary. In some aspects, an elevated privilege is needed in order to establish an intercept filter. Various techniques can be used to cause the intercept instantiator to execute at an elevated privilege level. In some aspects, the intercept instantiator executes as privileged code. The address of the entry point of the intercept instantiator may be provided to the Java application 110, or acquired by function within JNI 114. Thus, the application 110 may execute at a first privilege level, but when the intercept instantiator is called, the intercept instantiator can execute at an elevated privilege level. In alternative aspects, the intercept instantiator can execute as a separate process from Java application 110. The separate process may have an elevated privilege. A JNI 114 function may use interprocess communication techniques to communicate the request and directive to the intercept instantiator in the separate process.

At block 210, the intercept instantiator establishes the intercept filter. In some aspects, the intercept filter is established such that the intercept filter is “thread local.” For example, the intercept filter can be established such that the requested intercept of the function of the native service is performed for a thread of an application making the request. Other threads or processes that call the native service do not have the call to the function of native service intercepted. In some aspects where hook instructions are utilized to implement the intercept filter, a pointer to the hook instructions can be provided in metadata associated with the process that is maintained by the operating system. The metadata can associate the hook instructions with a native service and can include a pointer to the hook instructions. When a call is made to the native service, the pointer to the hook instructions is used to transfer control to the hook instructions, which are executed prior to the instructions of the native service. As an example, in z/OS implementations, a technique referred to as SVC (Supervisor Call) screening can be used to establish a pointer to the hook instructions in the Task Control Block (TCB) associated with a thread. The pointer to the hook instructions is inserted at the appropriate field of a subsystem screen table for the thread. Thus, the hook instructions are only executed when the thread makes the specified SVC to the native service. Other threads that do not have a modified TCB do not execute the hook instructions.

At block 212, the intercept instantiator associates the directive in the request with the function of the native service to be intercepted. For example, the intercept instantiator can place the parameter (and parameter values, if any) in a table or other data structure that associates the parameter and parameter values with the function of the native service that is to be intercepted.

At block 214, the intercept instantiator returns control to the requestor and the method ends. If the privilege was elevated at block 208, the intercept instantiator can return to the original privilege level.

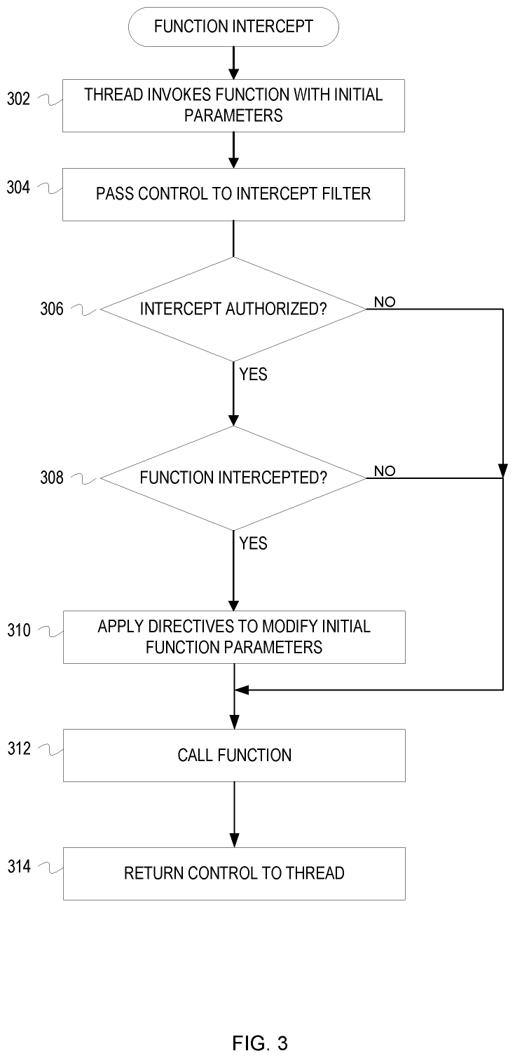

FIG. 3 is a flow chart illustrating operations of an intercept filter to customize native services according to aspects of the disclosure.

At block 302, a process calls an interface function to a native service. For example, a Java application can make a call to a JZOS library function that is an interface to a native service. The call to the interface function may have one or more initial parameters.

At block 304, control is passed to an intercept filter.

At block 306, the intercept filter determines whether or not the call to the process is authorized to have functions intercepted. If the process is not authorized to have functions intercepted, flow proceeds to block 312, where the function is called with the parameter list as initially established in the call to the JZOS interface function. If the process is authorized to have functions intercepted, flow proceeds to block 308.

At block 308, the intercept filter determines whether or not the call to the native service function is to be intercepted. In some aspects, the interface filter can apply a rule or rules to determine if the function call to the native service is to be intercepted. The rules can be established based on the directives received at block 202 (FIG. 2). For example, a rule could comprise a rule similar in form to “if the function name is X, then add parameter Y.” In alternative aspects, the interface filter determines if hook instructions have been established for the native service. The existence of hook instructions indicates that the function of the native service is being intercepted.

If the function is not intercepted, then flow proceeds to block 312, and the native service function is called without modified parameters, i.e., with the parameter list as initially established in the call to the JZOS interface function.

If the function is to be intercepted, the flow proceeds to block 310, where the intercept filter modifies the function parameter list according to the directives supplied at block 202 (FIG. 2). For example, the intercept filter may cause a parameter to be added to the parameter list of the function call. In some aspects, the parameter list can be a parameter block associated with the function call. The parameter block can be modified according to the directive supplied at block 202. In alternative aspects, a call stack can be modified according to the directive to modify parameters in the call stack. After the parameter list has been modified, flow proceeds to block 312, where the function is called with the modified parameter list.

In some aspects, the intercept filter may check to determine if the caller is authorized to perform intercept. If the caller is not authorized, then the request can be denied.

It will be appreciated that aspects of the above-described systems and methods can provide advantages over conventional systems. For example, in conventional systems, in order to provide a customized call to a native service, a custom interface (i.e., a custom JNI function) is developed. As noted above, each invocation of this customized call may cause the application to be executed on a general processor rather than a specialty processor. This can tax the general processor resources and result in underutilization of the specialty processors. The above-described systems and methods avoid this problem by instantiating an intercept filter that customizes the parameter lists for native service calls that are made via an interface function. Because native service is still invoked via the OS interface library, the application can remain eligible for execution on the specialty processor. This can improve the functioning of the computer system by providing a better workload allocation among the general processors and specialty processors.

### Variations

The discussion above has been provided in the context of a Java Virtual Machine executing applications that make calls to native services. However, the aspects of the disclosure are not limited to such environments. For example, the application may be an application running in a Linux or UNIX based operating system environment. The system may provide an interface library to Linux or UNIX system calls. An intercept filter can be established to modify parameters of function calls made to the interface library to add parameters that are not supported by the interface library, but are supported by the corresponding Linux or UNIX system calls.

Also, the discussion above has provided examples of intercepting function calls to native services via a Java-to-OS interface such as JZOS. Those of skill in the art having the benefit of the disclosure will appreciate that other functions can be intercepted. For example, calls to native services or other native functions that result from calls to standard Java interfaces can also be intercepted using the methodology described above.

Additionally, some aspects of the discussion above have been provided in the context of a mainframe operating environment. However, the aspects of the disclosure are not limited to such environments. The techniques disclosed herein can be applied to any multi-processor environment that includes general purpose processors and processors dedicated for special purposes.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, some operations depicted FIGS. 2 and 3 may be performed in parallel or in a different order than shown. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

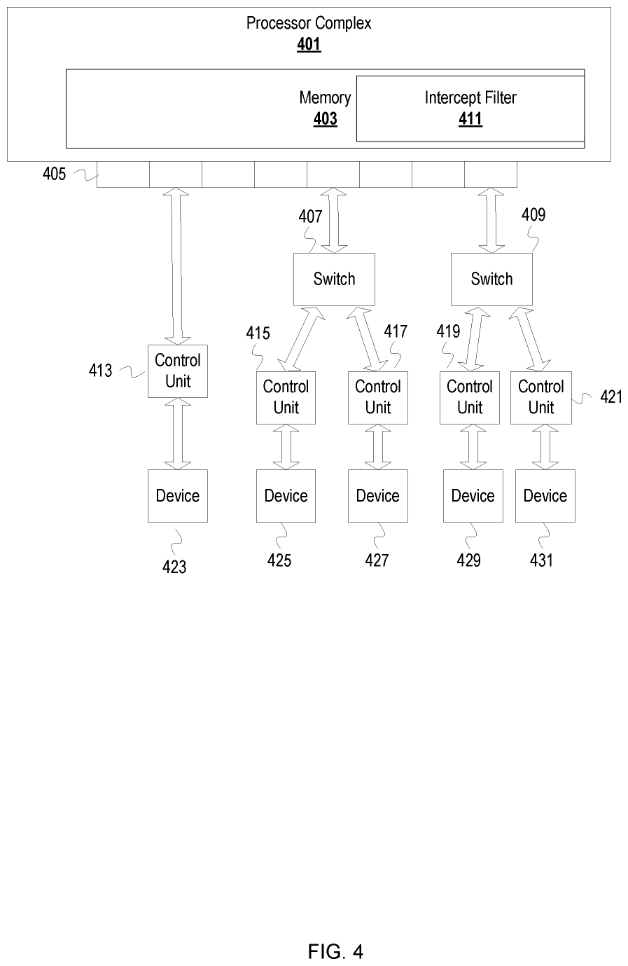

FIG. 4 depicts an example mainframe with an intercept filter. The mainframe includes a processor complex 401, which is comprised of multiple processors, such as general processors and specialty processors. Each of the processors can be single core, multi-core, single threaded, multithreaded, etc. The processor complex includes main memory/storage 403. The main memory 403 comprises an intercept filter 411. The interface filter 411 comprises a set of instructions that are executed when an application calls a native service via an interface that is restricted with respect to the parameters can be provided via the interface. The interface filter can add parameters supported by the native service as specified via an earlier supplied directive. Through a plurality of input/output channels 405, the processor complex 401 received input and provides output to a control unit 413, a switch 407, and a switch 409. The control unit 413 interfaces with a device 423. The switch 407 interfaces with control units 415, 417. The control unit 415 interfaces with a device 425 and the control unit 417 interfaces with a device 427. The switch 409 interfaces with control units 419, 421. The control unit 419 interfaces with a device 429 and the control unit 421 interfaces with a device 431.

While the aspects of the disclosure are described with reference to various implementations and exploitations, it will be understood that these aspects are illustrative and that the scope of the claims is not limited to them. In general, techniques for customizing services as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
instantiating a process, wherein the process includes a call to an interface function for a native function, wherein the interface function provides a first set of parameters that are a subset of a second set of parameters for the native function;
receiving a directive for the interface function, wherein the directive specifies a parameter in the second set of parameters;
establishing an intercept filter for the native function;
calling, by the process, the interface function with a call parameter from the first set of parameters; and
in response to calling the interface function, adding, by the intercept filter, a parameter from the second set of parameters to the call parameter in accordance with the directive.

2. The method of claim 1 wherein the process executes at a first privilege level and the native function executes at a second privilege level greater than the first privilege level.

3. The method of claim 1, wherein establishing the intercept filter for the native function comprises establishing the intercept filter as local to the process.

4. The method of claim 1, further comprising determining that the process has sufficient authorization to establish the intercept filter.

5. The method of claim 1 wherein the process executes on a first processor, and wherein establishing the interface function is constrained by an operating system to execute on a second processor different from the first processor.

6. The method of claim 1, wherein establishing the intercept filter for the native function comprises establishing the intercept filter as a hook associated with the native function.

7. The method of claim 1, wherein receiving the directive comprises receiving a rule specifying a condition for adding the parameter from the second set of parameters.

8. The method of claim 1, wherein the process comprises a thread of an application.

9. An apparatus comprising:
a first processor and a second processor; and
a computer-readable medium having instructions stored thereon that are executable by at least one of the first processor and the second processor to cause the apparatus to,
receive, within an application, a directive for an interface function for a native function, wherein the interface function provides a first set of parameters that are a subset of a second set of parameters for the native function, and wherein the directive specifies a parameter in the second set of parameters;
establish a hook for the native function;
process a call to the interface function with a call parameter from the first set of parameters; and
cause the hook to be executed prior to the native function, wherein the hook adds a parameter from the second set of parameters to the call parameter in accordance with the directive.

10. The apparatus of claim 9 wherein the application executes at a first privilege level and the instructions to establish the hook for the native function execute at a second privilege level having greater privilege than the first privilege level.

11. The apparatus of claim 9, wherein the hook for the native function is local to the application.

12. The apparatus of claim 9 wherein the application comprises a JAVA application.

13. The apparatus of claim 9 wherein the interface function comprises a JZOS service.

14. The apparatus of claim 9, wherein the instructions for the application execute on the first processor, and wherein the instructions to establish the hook for the native function are not eligible to execute on the first processor and execute on the second processor.

15. A non-transitory machine-readable medium having instructions stored thereon that are executable by a computing device to perform operations comprising:
receive, within an application, a directive for an interface function for a native function, wherein the interface function provides a first set of parameters that are a subset of a second set of parameters for the native function, and wherein the directive specifies a parameter in the second set of parameters;
establish an intercept filter for the native function;
call, by the application, the interface function with a call parameter from the first set of parameters; and
in response to the call of the interface function, add, by the intercept filter, a parameter from the second set of parameters to the call parameter in accordance with the directive.

16. The non-transitory machine-readable medium of claim 15 wherein the application executes at a first privilege level and the native function executes at a second privilege level greater than the first privilege level.

17. The non-transitory machine-readable medium of claim 15, wherein the instructions further comprise instructions to cause the computing device to determine, prior to calling the native function, that sufficient authorization exists to call the native function with the added parameter from the second set of parameters.

18. The non-transitory machine-readable medium of claim 15 wherein the application executes on a first processor of the computing device, and wherein instructions to establish the interface function execute on a second processor of the computing device different from the first processor.

19. The non-transitory machine-readable medium of claim 15, wherein the instructions to establish the intercept filter for the native function comprise instructions to establish the intercept filter as a hook associated with the native function.

20. The non-transitory machine-readable medium of claim 15, wherein the directive comprises a rule specifying a condition for adding the parameter from the second set of parameters to the call parameter.
